(19) United States
(12) Patent Application Publication
(10) Pub. No.: US 2015/0211461 A1
(43) Pub. Date: Jul. 30, 2015

(54) FUEL INJECTORS WITH NON-COINED THREE-DIMENSIONAL NOZZLE INLET FACE

(71) Applicant: 3M INNOVATIVE PROPERTIES COMPANY, St. Paul, MN (US)

(72) Inventors: Ryan C. Shirk, Mendota Heights, MN (US); Barry S. Carpenter, Oakdale, MN (US); David H. Redinger, Afton, MN (US); Scott M. Schnobrich, Cottage Grove, MN (US)

(21) Appl. No.: 14/417,833

(22) PCT Filed: Aug. 1, 2013
(86) PCT No.: PCT/US2013/053178

§ 371 Date: Jan. 28, 2015

Related U.S. Application Data
(60) Provisional application No. 61/678,288, filed on Aug. 1, 2012.

(51) Int. Cl. F02M 61/18

(52) U.S. Cl. CPC F02M 61/1806; F02M 61/1853; F02M 61/1886

(57) ABSTRACT

Nozzles and method of making the same are disclosed. The disclosed nozzles have a non-coined three-dimensional inlet face and an outlet face opposite the inlet face. The nozzles may have one or more nozzle through-holes extending from the inlet face to the outlet face. Fuel injectors containing the nozzle are also disclosed. Methods of making and using nozzles and fuel injectors are further disclosed.

### FIELD OF THE INVENTION

This invention generally relates to nozzles suitable for use in a fuel injector for an internal combustion engine. The invention is further applicable to fuel injectors incorporating such nozzles. This invention also relates to methods of making such nozzles, as well as methods of making fuel injectors incorporating such nozzles. The invention further relates to methods of using nozzles and fuel injectors in vehicles.

### BACKGROUND

There are three basic types of fuel injector systems. Those that use port fuel injection (PFI), gasoline direct injection (GDI), and direct injection (DI). While PFI and GDI use gasoline as the fuel, DI uses diesel fuel. Efforts continue to further develop fuel injector nozzles and fuel injection systems containing the same so as to potentially increase fuel efficiency and reduce hazardous emissions of internal combustion engines, as well as reduce the overall energy requirements of a vehicle comprising an internal combustion engine.

### SUMMARY OF THE INVENTION

The present invention is directed to fuel injector nozzles. In one exemplary embodiment, the fuel injector nozzle comprises: a non-coined three-dimensional inlet face comprising a first inlet surface and a second inlet surface; an outlet face opposite the inlet face; and one or more first nozzle through-holes and one or more second nozzle through-holes, with each first nozzle through-hole comprising at least one inlet opening on the first inlet surface connected to at least one outlet opening on the outlet face by a cavity defined by an interior surface, and each second nozzle through-hole comprising at least one inlet opening on the second inlet surface connected to at least one outlet opening on the outlet face by a cavity defined by an interior surface, wherein the first inlet surface is not coplanar with the second inlet surface.

In another exemplary embodiment, the fuel injector nozzle comprises: a non-coined three-dimensional inlet face comprising a first inlet surface and a second inlet surface; an outlet face opposite the inlet face; and one or more first nozzle through-holes and one or more second nozzle through-holes, with each first nozzle through-hole comprising at least one inlet opening on the first inlet surface connected to at least one outlet opening on the outlet face by a cavity defined by an interior surface, and each second nozzle through-hole comprising at least one inlet opening on the second inlet surface connected to at least one outlet opening on the outlet face by a cavity defined by an interior surface, wherein a perpendicular wall portion of the inlet face separates the first inlet surface and the second inlet surface.

The present invention is further directed to fuel injectors. In one exemplary embodiment, the fuel injector comprises any one of the herein-disclosed nozzles of the present invention.

The present invention is even further directed to fuel injection systems. In one exemplary embodiment, the fuel injection system comprises any one of the herein-disclosed nozzles or fuel injectors of the present invention.

In another exemplary embodiment, the fuel injection system of the present invention comprises a fuel injection system of a vehicle, wherein the fuel injection system comprises: (I) a nozzle comprising a non-coined three-dimensional inlet face comprising a first inlet surface and a second inlet surface; an outlet face opposite the inlet face; and one or more first nozzle through-holes and one or more second nozzle through-holes, with each first nozzle through-hole comprising at least one inlet opening on the first inlet surface connected to at least one outlet opening on the outlet face by a cavity defined by an interior surface, and each second nozzle through-hole comprising at least one inlet opening on the second inlet surface connected to at least one outlet opening on the outlet face by a cavity defined by an interior surface, wherein the first inlet surface is not coplanar with the second inlet surface; and (II) a fuel injector valve having a fuel injector valve contact surface; wherein the fuel injection system provides at least three levels of fluid flow through the nozzle depending on a position of the fuel injector valve relative to the nozzle. The at least three levels of fluid flow through the nozzle may comprise (1) no fluid flow; (2) partial fluid flow, wherein fluid flows through the one or more second nozzle through-holes; and (3) full fluid flow, wherein fluid flows through the one or more first nozzle through-holes and the one or more second nozzle through-holes.

The present invention is also directed to methods of making nozzles. In one exemplary embodiment, the method of making a nozzle of the present invention comprises making any of the herein-described nozzles.

In another exemplary embodiment, the method of making a nozzle of the present invention comprises: forming a nozzle comprising a non-coined three-dimensional inlet face comprising a first inlet surface and a second inlet surface; an outlet face opposite the inlet face; and one or more first nozzle through-holes and one or more second nozzle through-holes, with each first nozzle through-hole comprising at least one inlet opening on the first inlet surface connected to at least one outlet opening on the outlet face by a cavity defined by an interior surface, and each second nozzle through-hole comprising at least one inlet opening on the second inlet surface connected to at least one outlet opening on the outlet face by a cavity defined by an interior surface, wherein the first inlet surface is not coplanar with the second inlet surface.

In another exemplary embodiment, the method of making a nozzle of the present invention comprises: forming a nozzle comprising a non-coined three-dimensional inlet face comprising a first inlet surface and a second inlet surface; an outlet face opposite the inlet face; and one or more first nozzle through-holes and one or more second nozzle through-holes, with each first nozzle through-hole comprising at least one inlet opening on the first inlet surface connected to at least one outlet opening on the outlet face by a cavity defined by an interior surface, and each second nozzle through-hole comprising at least one inlet opening on the second inlet surface connected to at least one outlet opening on the outlet face by a cavity defined by an interior surface, wherein a perpendicular wall portion of the inlet face separates (i) at least one inlet opening of the one or more first nozzle through-holes from (ii) at least one inlet opening of the one or more second nozzle through-holes.

The present invention is also directed to methods of making fuel injectors. In one exemplary embodiment, the method of making a fuel injector comprises incorporating any one of the herein-described nozzles into the fuel injector.

The present invention is also directed to methods of making fuel injection systems of a vehicle. In one exemplary embodiment, the method of making a fuel injection system of a vehicle comprises incorporating any one of the herein-described nozzles or fuel injectors into the fuel injection system.

### BRIEF DESCRIPTION OF DRAWINGS

The invention may be more completely understood and appreciated in consideration of the following detailed description of various embodiments of the invention in connection with the accompanying drawings, in which:

FIG. 1 is a side view of an exemplary nozzle of the present invention;

FIG. 2 is a perspective view of an exemplary fuel injector valve suitable for use with the exemplary nozzle shown in FIG. 1;

FIG. 3A is a cross-sectional view of the exemplary nozzle shown in FIG. 1 and the exemplary fuel injector valve shown in FIG. 2 when in a “fully closed” position;

FIG. 3B is a cross-sectional view of the exemplary nozzle shown in FIG. 1 and the exemplary fuel injector valve shown in FIG. 2 when in a “partially open” position;

FIG. 3C is a cross-sectional view of the exemplary nozzle shown in FIG. 1 and the exemplary fuel injector valve shown in FIG. 2 when in a “fully open” position;

FIG. 4A is a perspective view of another exemplary nozzle of the present invention;

FIG. 4B is a top view of the exemplary nozzle shown in FIG. 4A;

FIG. 4C is a cross-sectional view of the exemplary nozzle shown in FIG. 4A with an exemplary fuel injector valve positioned along an inlet face of the exemplary nozzle in a “fully closed” position;

FIG. 5 is a cross-sectional view of another exemplary nozzle of the present invention;

FIG. 6 is a cross-sectional view of another exemplary nozzle of the present invention;

FIG. 7 is a cross-sectional view of an exemplary fuel injector system of the present invention utilizing an exemplary nozzle of the present invention, wherein the nozzle comprises one or more inlet face features that reduce a SAC volume of the fuel injector system;

FIG. 8 is a schematic of an exemplary fuel injector system of the present invention;

FIG. 9 is a cross-sectional view of another exemplary nozzle of the present invention;

FIG. 10 is a cross-sectional view of another exemplary nozzle of the present invention;

FIG. 11 is a schematic of an exemplary vehicle comprising a fuel injector system of the present invention;

FIG. 12 is a cross-sectional view of an exemplary method step wherein nozzle material is removed from a nozzle using a contacting tool;

FIG. 13 is a perspective view of an exemplary contacting tool suitable for use in the material removal step shown in FIG. 12;

FIGS. 14a-e depict cross-sectional views of exemplary contacting tool suitable for use in the material removal step shown in FIG. 12;

FIGS. 15a-e depict cross-sectional views of exemplary outlet surface features formed using the contacting tools shown in FIGS. 14a-e; and

FIG. 16 is a perspective view of another exemplary contacting tool suitable for use in the material removal step shown in FIG. 12.

In the specification, a same reference numeral used in multiple figures refers to the same or similar elements having the same or similar properties and functionalities.

### DETAILED DESCRIPTION

The disclosed nozzles represent improvements to nozzles disclosed in (1) International Patent Application Publication WO2011/014607, which published on February 03, 2011, and (2) International Patent Application Serial No. US2012/023624 (3M Docket No. 67266W0003 entitled “Nozzle and Method of Making Same”) filed on Feb. 2, 2012, the subject matter and disclosure of both of which are herein incorporated by reference in their entirety. The disclosed nozzles provide one or more advantages over prior nozzles as discussed herein. For example, the disclosed nozzles can advantageously be incorporated into fuel injector systems to improve fuel efficiency. The disclosed nozzles can be fabricated using multiphoton, such as two photon, processes like those disclosed in International Patent Application Publication WO2011/014607 and International Patent Application Serial No. US2012/023624. In particular, multiphoton processes can be used to fabricate various microstructures, which can at least include one or more hole forming features. Such hole forming features can, in turn, be used as molds to fabricate holes for use in nozzles or other applications.

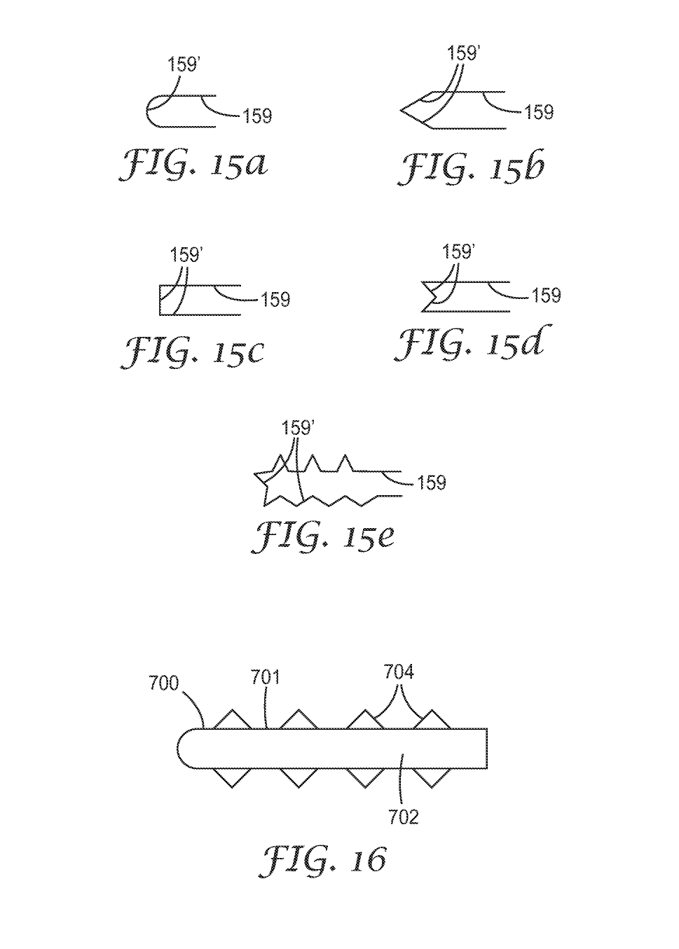

It should be understood that the term “nozzle” may have a number of different meanings in the art. In some specific references, the term nozzle has a broad definition. For example, U.S. Patent Publication No. 2009/0308953 A1 (Palestrant et al.), discloses an “atomizing nozzle” which includes a number of elements, including an occluder chamber 50. This differs from the understanding and definition of nozzle put forth herewith. For example, the nozzle of the current description would correspond generally to the orifice insert 24 of Palestrant et al. In general, the nozzle of the current description can be understood as the final tapered portion of an atomizing spray system from which the spray is ultimately emitted, see e.g., Merriam Webster's dictionary definition of nozzle (“a short tube with a taper or constriction used (as on a hose) to speed up or direct a flow of fluid.” Further understanding may be gained by reference to U.S. Pat. No. 5,716,009 (Ogihara et al.) issued to Nippondenso Co., Ltd. (Kariya, Japan). In this reference, again, fluid injection “nozzle” is defined broadly as the multi-piece valve element 10 (“fuel injection valve 10 acting as fluid injection nozzle. . .”—see col. 4, lines 26-27 of Ogihara et al.). The current definition and understanding of the term “nozzle” as used herein would relate, e.g., to first and second orifice plates 130 and 132 and potentially sleeve 138 (see FIGS. 14 and 15 of Ogihara et al.), for example, which are located immediately proximate the fuel spray. A similar understanding of the term “nozzle” to that described herein is used in U.S. Pat. No. 5,127,156 (Yokoyama et al.) to Hitachi, Ltd. (Ibaraki, Japan). There, the nozzle 10 is defined separately from elements of the attached and integrated structure, such as “swirler” 12 (see FIG. 1(II)). The above-defined understanding should be understood when the term “nozzle” is referred to throughout the remainder of the description and claims.

The disclosed nozzles include one or more nozzle through-holes strategically incorporated into the nozzle structure. The one or more nozzle through-holes provide one or more of the following properties to the nozzle: (1) the ability to provide variable fluid flow through the nozzle (e.g., by opening or closing off one or more one or more nozzle through-holes), (2) the ability to provide multi-directional fluid flow relative to an outlet face of the nozzle, and (3) the ability to provide multi-directional off-axis fluid flow relative to a central normal line extending perpendicularly through the nozzle outlet face.

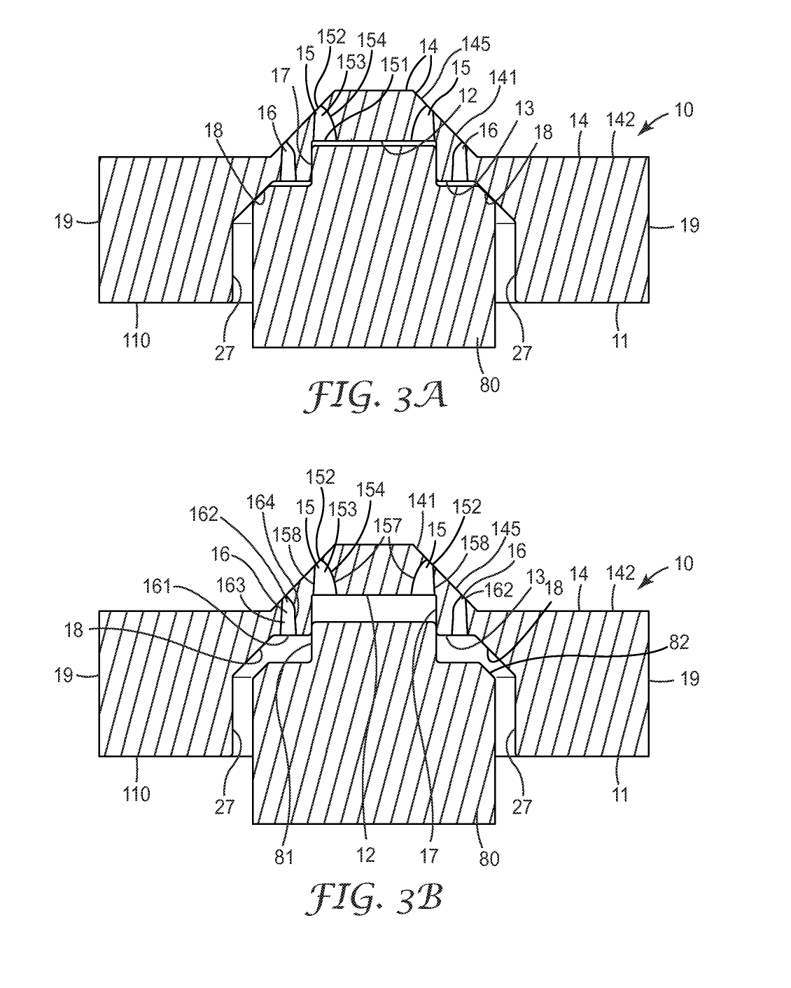

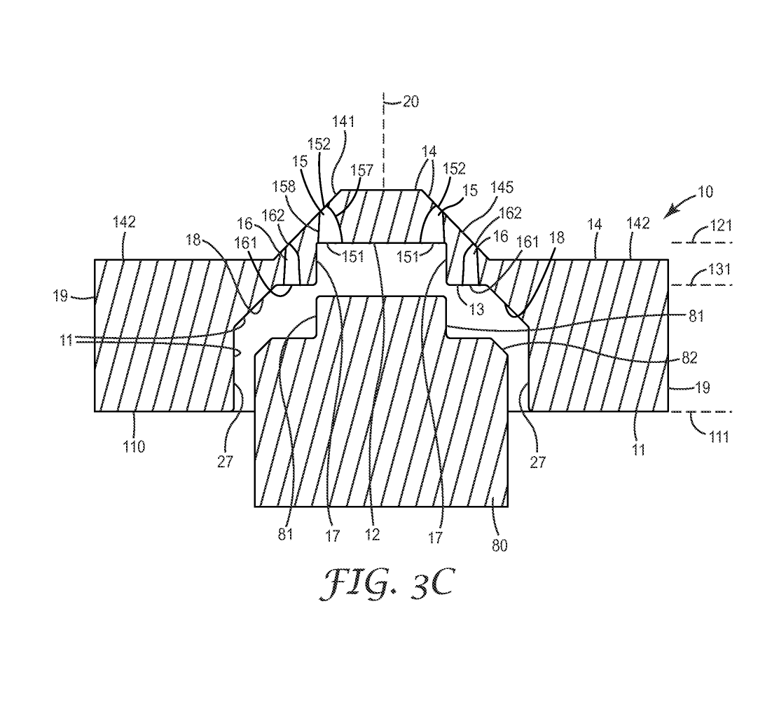

FIGS. 1 and 3A-3C depict various views of an exemplary nozzle 10 of the present invention. As shown in FIGS. 1 and 3A-3C, nozzle 10 comprises a non-coined three-dimensional inlet face 11 comprising a first inlet surface 12 and a second inlet surface 13; an outlet face 14 opposite inlet face 11; and one or more first nozzle through-holes 15 and one or more second nozzle through-holes 16. As used herein, the term “non-coined” refers to inlet face 11 of nozzle 10 not being formed by a deformation process like, for example, a coining or stamping operation. As discussed further below, inlet face 11 of nozzle 10 may be formed by, for example, a deposition/molding process such as a two-photon polymerization/molding process.

Each first nozzle through-hole 15 comprises at least one inlet opening 151 on first inlet surface 12 connected to at least one outlet opening 152 on outlet face 14 by a cavity 153 defined by an interior surface 154. Each second nozzle through-hole 16 comprises at least one inlet opening 161 on second inlet surface 13 connected to at least one outlet opening 162 on outlet face 14 by a cavity 163 defined by an interior surface 164.

As shown in FIGS. 1 and 3A-3C, first inlet surface 12 is not coplanar with second inlet surface 13. As used herein, the term “coplanar” is used to describe continuous or discontinuous surface portions that fall within a given plane, the given plane having no or some curvature within the plane (i.e., the continuous or discontinuous surface portions fall within a non-curved plane or within a curved surface; the term coplanar as used herein encompasses two portions (continuous or discontinuous portions) of a curved surface). In addition to not being coplanar, first inlet surface 12 may be parallel with second inlet surface 13 as shown in FIGS. 1 and 3A-3C.

Although each of first inlet surface 12 and second inlet surface 13 are shown in FIGS. 1 and 3A-3C as being substantially flat (i.e., having no curvature), it should be noted that each of first inlet surface 12 and second inlet surface 13 may independently have a radius of curvature within the inlet surface portion. Typically, when present, first inlet surface 12 and second inlet surface 13 each independently have a radius of curvature of up to about 4 m (or any radius of curvature up to 4 m, typically greater than 10 μm and any value or range of values between 10 μm and 4 m, in increments of 1.0 μm). As shown in FIGS. 1 and 3A-3C, first inlet surface 12 is separated from second inlet surface 13 by a perpendicular wall portion 17 of said inlet face 11. As further shown in FIGS. 1 and 3A-3C, one or more inlet openings 151 on first inlet surface 12 are separated from one or more inlet openings 161 on second inlet surface 13 by perpendicular wall portion 17.

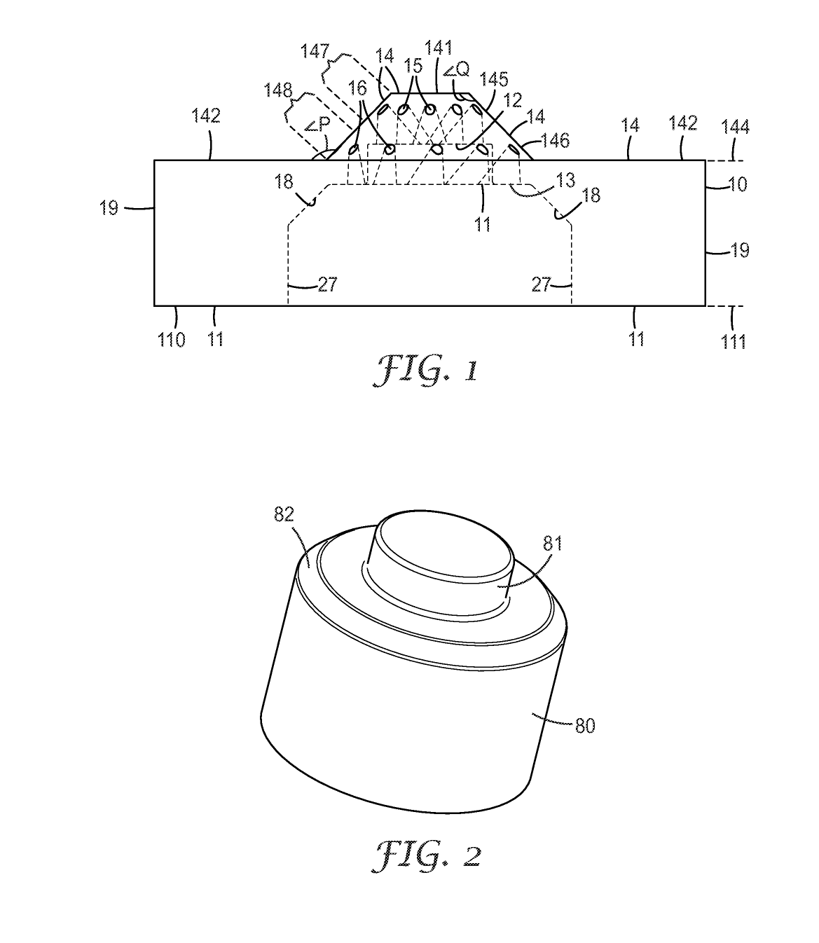

As shown in FIGS. 2 and 3A-3C, nozzle 10 may be used in combination with an exemplary fuel injector valve 80. Fuel injector valve 80 comprises a fuel injector valve contact surface 81, at least a portion of which is operatively adapted (e g , dimensioned, configured or otherwise designed) and sized to extend along perpendicular wall portion 17 of inlet face 11. Fuel injector valve 80 further comprises a fuel injector valve sealing surface 82, at least a portion of which is operatively adapted (e.g., dimensioned, configured or otherwise designed) and sized to contact and seal with second valve sealing surface 18 of inlet face 11.

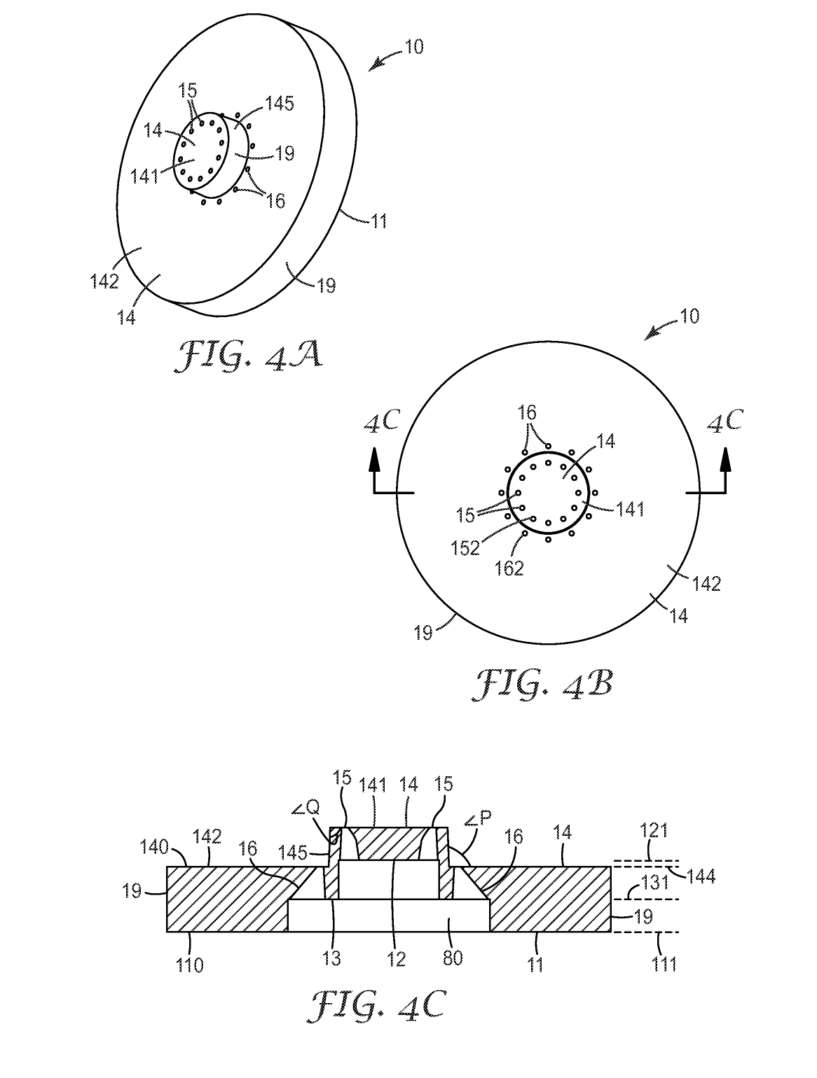

Fuel injector valve 80 is movable within nozzle 10 so as to selectively open or close one or more inlet openings 151 on first inlet surface 12 and one or more inlet openings 161 on second inlet surface 13. FIG. 3A provides a cross-sectional view of nozzle 10 and fuel injector valve 80 in a “fully closed” position, wherein all of inlet openings 151 on first inlet surface 12 and inlet openings 161 on second inlet surface 13 are closed (i.e., no fluid flow). FIG. 3B provides a cross-sectional view of nozzle 10 and fuel injector valve 80 when in a “partially open” position, wherein inlet openings 151 on first inlet surface 12 are closed (i.e., no fluid flow) and inlet openings 161 on second inlet surface 13 are open (i.e., to allow fluid flow). FIG. 3C provides a cross-sectional view of nozzle 10 and fuel injector valve 80 in a “fully open” position, wherein all of inlet openings 151 on first inlet surface 12 and inlet openings 161 on second inlet surface 13 are open (i.e., to allow fluid flow). FIGS. 4A-4C provide various views of another nozzle 10 of the present invention. As shown in FIGS. 4A-4C, outlet openings 152 and 162 of nozzle 10 are not positioned along the same surface, but instead are positioned along two separate outlet surfaces of inlet face 14. In particular, outlet openings 152 are positioned along a first outlet surface 141 (i.e., in this embodiment, also referred to herein as an uppermost outlet surface 141) and outlet openings 162 of nozzle 10 are positioned along a second outlet surface 142 (i.e., in this embodiment, also referred to herein as a lowermost outlet surface 142).

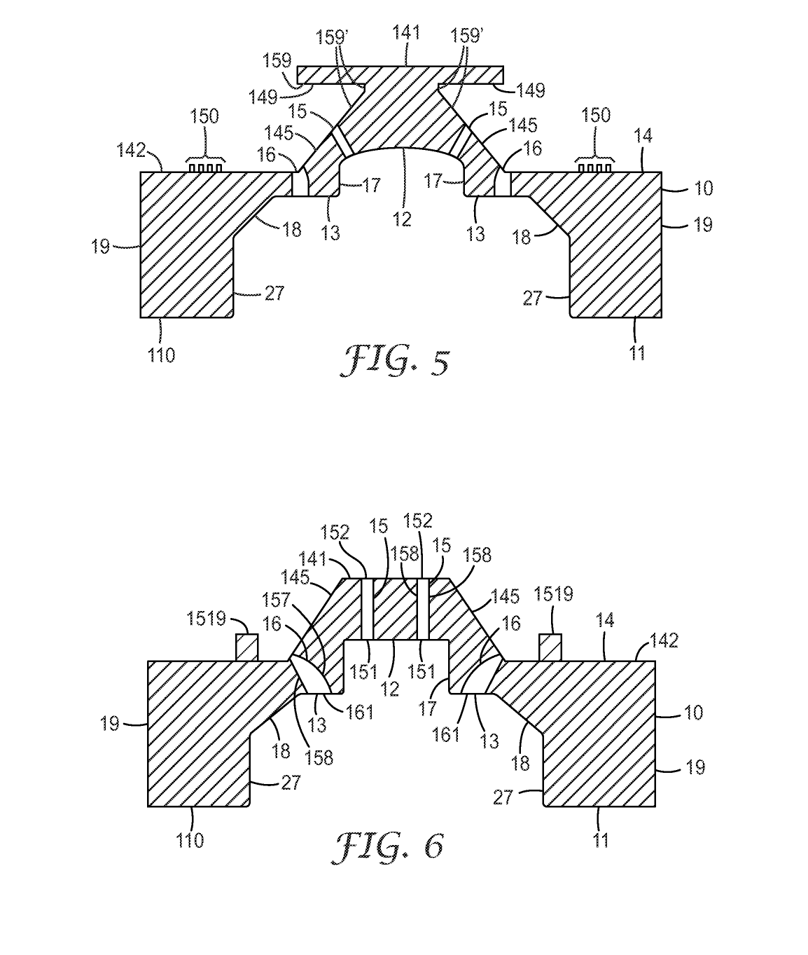

As shown in FIGS. 5-6, nozzles 10 of the present invention may further comprise a number of optional, additional features. Suitable optional, additional features include, but are not limited to, one or more overlapping outlet surface portions 149, one or more anti-coking microstructures 150 positioned along any portion of outlet face 14, and one or more fluid impingement structures along any portion of outlet face 14.

As shown in FIGS. 1 and 3A-6, nozzles 10 of the present invention may comprise nozzle through-holes 15 and 16, wherein each nozzle through-hole 15/16 independently comprises the following features: (i) an inlet opening 151/161 shape, (ii) an outlet opening 152/163 shape, and (iii) an internal surface 154 profile that may include one or more curved sections 157, one or more linear sections 158, or a combination of one or more curved sections 157 and one or more linear sections 158. Selection of these features for each independent nozzle through-hole 15/16 enables nozzle 10 to provide (1) substantially equal fluid flow through nozzle through-holes 15/16, (2) variable fluid flow through nozzle through-holes 15/16 (i.e., fluid flow that is not the same from one nozzle through-holes 15/16 to another), (3) single- or multi-directional fluid streams exiting nozzle through-holes 15/16, (4) linear and/or curved fluid streams exiting nozzle through-holes 15/16, and (5) parallel and/or divergent and/or parallel followed by divergent fluid streams exiting nozzle through-holes 15/16.

In some embodiments, at least one of nozzle through-holes 15/16 has an inlet opening 151/161 axis of flow, a cavity 153/163 axis of flow and an outlet opening 152/162 axis of flow, and at least one axis of flow is different from at least one other axis of flow. As used herein, the “axis of flow” is defined as the central axis of a stream of fuel as the fuel flows into, through or out of nozzle through-hole 15/16. In the case of a nozzle through-hole 15/16 having multiple inlet openings 151/161, multiple outlet openings 152/162 or both, the nozzle through-hole 15/16 can have a different axis of flow corresponding to each of the multiple openings 151/152/161/162.

In some embodiments, inlet opening 151/161 axis of flow may be different from outlet opening 152/162 axis of flow. In other embodiments, each of inlet opening 151/161 axis of flow, cavity 153/163 axis of flow and outlet opening 152/162 axis of flow are different from one another. In other embodiments, nozzle through-hole 15/16 has a cavity 153/163 that is operatively adapted (e.g., dimensioned, configured or otherwise designed) such that fuel flowing therethrough has an axis of flow that is curved.

Examples of factors that contribute to such differences in axis of flow may include, but are not be limited to, any combination of: (1) a different angle between (i) cavity 153/163 and (ii) inlet face 11 and/or outlet face 14, (2) inlet openings 151/161 and/or cavities 153/163 and/or outlet openings 152/162 not being aligned or parallel to each other, or aligned along different directions, or parallel but not aligned, or intersecting but not aligned, and/or (3) any other conceivable geometric relationship two or three non-aligned line segments could have.

The disclosed nozzles 10 may comprise (or consist essentially of or consist of) any one of the disclosed nozzle features or any combination of two or more of the disclosed nozzle features. In addition, although not shown in the figures and/or described in detail herein, the nozzles 10 of the present invention may further comprise one or more nozzle features disclosed in (1) U.S. Provisional Patent Application Ser. No. 61/678,475 (3M Docket No. 69909US002 entitled “GDI Fuel Injectors with Non-Coined Three-Dimensional Nozzle Outlet Face”) filed on Aug. 1, 2012, (2) U.S. Provisional Patent Application Ser. No. 61/678,356 (3M Docket No. 69910US002 entitled “Targeting of Fuel Output by Off-Axis Directing of Nozzle Output Streams”) filed on Aug. 1, 2012, (3) U.S. Provisional Patent Application Ser. No. 61/678,330 (3M Docket No. 69911US002 entitled “Fuel Injector Nozzles with at Least One Multiple Inlet Port and/or Multiple Outlet Port”) filed on Aug. 1, 2012, and (4) U.S. Provisional Patent Application Ser. No. 61/678,305 (3M Docket No. 69912US002 entitled “Fuel Injectors with Improved Coefficient of Fuel Discharge”) filed on Aug. 1, 2012, the subject matter and disclosure of each of which is herein incorporated by reference in its entirety.

The disclosed nozzles 10 may be formed using any method as long as the resulting inlet face 11 of the nozzle 10 has inlet face 11 features as described herein. Although the methods of making nozzles 10 of the present invention are not limited to the methods disclosed in International Patent Application Serial No. US2012/023624, nozzles 10 of the present invention may be formed using the methods as disclosed in International Patent Application Serial No. US2012/023624. See, in particular, the method steps described in reference to FIGS. 1A-1M of International Patent Application Serial No. US2012/023624.

### ADDITIONAL EMBODIMENTS

### Nozzle Embodiments

1. A fuel injector nozzle 10 comprising: a non-coined three-dimensional inlet face 11 comprising a first inlet surface 12 and a second inlet surface 13; an outlet face 14 opposite said inlet face 11; and one or more first nozzle through-holes 15 and one or more second nozzle through-holes 16, with each said first nozzle through-hole 15 comprising at least one inlet opening 151 on said first inlet surface 12 connected to at least one outlet opening 152 on said outlet face 14 by a cavity 153 defined by an interior surface 154, and each said second nozzle through-hole 16 comprising at least one inlet opening 161 on said second inlet surface 13 connected to at least one outlet opening 162 on said outlet face 14 by a cavity 163 defined by an interior surface 164, wherein said first inlet surface 12 is not coplanar with said second inlet surface 13. First inlet surface 12 is typically parallel with second inlet surface 13, but not coplanar with second inlet surface 13. See, embodiment 4 below. In some embodiments, a majority (i.e., greater than 50% and up to 100%) of an overall length of first inlet surface 12 is parallel with a majority (i.e., greater than 50% and up to 100%) of an overall length of second inlet surface 13, while in other embodiments, only a portion (i.e., less than 50%) of an overall length of first inlet surface 12 is parallel with a portion (i.e., less than 50%) of an overall length of second inlet surface 13.
2. The nozzle 10 of embodiment 1, wherein said inlet face 11 further comprises a first valve sealing surface 17 between said first inlet surface 12 and said second inlet surface 13, with said first valve sealing surface 17 being configured or otherwise operatively adapted (e g , dimensioned, configured or otherwise designed) to seal with a fuel injector valve 80 so as to allow a fuel (or fluid) (not shown) to pass through said second nozzle through-holes 16 but not said first nozzle through-holes 15.
3. The nozzle 10 of embodiment 1 or 2, wherein said inlet face 11 further comprises a second valve sealing surface 18 being configured or otherwise operatively adapted (e.g., dimensioned, configured or otherwise designed) to seal with a fuel injector valve 80 so as to prevent a fuel (not shown) from passing through said second nozzle through-holes 16.
4. The nozzle 10 of any one of embodiments 1 to 3, wherein said first inlet surface 12 and said second inlet surface 13 are exactly or generally parallel to each other.
5. The nozzle 10 of any one of embodiments 2 to 4, wherein said first valve sealing surface 17 is configured or otherwise operatively adapted (e g , dimensioned, configured or otherwise designed) to seal with an exterior sealing surface 81 of a fuel injector valve 80 so as to prevent a fuel (not shown) from passing through said one or more first nozzle through-holes 15.
6. The nozzle 10 of any one of embodiments 2 to 5, wherein said first valve sealing surface 17 is exactly or generally perpendicular to at least one of said first inlet surface 12 and said second inlet surface 13.
7. The nozzle 10 of any one of embodiments 1 to 6, wherein said outlet face 14 comprises a first outlet surface 141 and a second outlet surface 142, with each outlet opening 152 of said one or more first nozzle through-holes 15 being on said first outlet surface 141, each outlet opening 162 of said one or more second nozzle through-holes 16 being on said second outlet surface 142, and said first outlet surface 141 is not coplanar with said second outlet surface 142.
8. The nozzle 10 of embodiment 7, wherein said first outlet surface 141 and said second outlet surface 142 are exactly or generally parallel to each other.
9. The nozzle 10 of any one of embodiments 1 to 6, wherein said outlet face 14 comprises a first outlet surface 145 and a second outlet surface 142, with said first outlet surface 145 being disposed at an acute angle to said second outlet surface 142, and each outlet opening 152/162 being on said first outlet surface 145.
10. A fuel injector nozzle 10 comprising: a non-coined three-dimensional inlet face 11 comprising a first inlet surface 12 and a second inlet surface 13; an outlet face 14 opposite said inlet face 11; and one or more first nozzle through-holes 15 and one or more second nozzle through-holes 16, with each said first nozzle through-hole 15 comprising at least one inlet opening 151 on said first inlet surface 12 connected to at least one outlet opening 152 on said outlet face 13 by a cavity 153 defined by an interior surface 154, and each said second nozzle through-hole 16 comprising at least one inlet opening 161 on said second inlet surface 13 connected to at least one outlet opening 162 on said outlet face 13 by a cavity 163 defined by an interior surface 164, wherein a perpendicular wall portion 17 of said inlet face 11 separates said first inlet surface 12 and said second inlet surface 13.
11. The nozzle 10 of any one of embodiments 1 to 10, wherein along said inlet face 11 between an outer periphery 19 of said nozzle 10 and a nozzle central axis 20 extending along a normal line perpendicular to said outer periphery 19, said inlet face 11 comprises at least two perpendicular wall portions 17/27 of said inlet face 11 separated from one another by an intermediate wall portion 13/18 of said inlet face 11.
12. The nozzle 10 of embodiment 11, wherein said at least two perpendicular wall portions 17/27 of said inlet face 11 comprise two concentrically-oriented perpendicular wall portions 17/27 of said inlet face 11.

13. The nozzle 10 of any one of embodiments 10 to 12, wherein each perpendicular wall portion 17/27 has a circular cross-sectional configuration (or square, or triangular, or star-shaped, or any other polygon shape) as viewed along a nozzle central axis 20 extending along a normal line perpendicular to an outer periphery 19 of said nozzle 10.
14. The nozzle 10 of any one of embodiments 10 to 13, wherein each perpendicular wall portion 17/27 of said inlet face 11 is substantially parallel to a nozzle central axis 20 extending along a normal line perpendicular to an outer periphery 19 of said nozzle 10.
15. The nozzle 10 of any one of embodiments 11 to 14, wherein said intermediate wall portion 13/18 of said inlet face 11 comprises a first valve sealing surface 18.
16. The nozzle 10 of any one of embodiments 1 to 15, wherein (i) an outer perimeter portion 110 of said inlet face 11 is within an inlet face plane 111, (ii) an outer perimeter portion 140 of said outlet face 14 is within an outlet face plane 144, and (iii) said inlet face plane 111 is substantially parallel to said outlet face plane 140.
17. The nozzle 10 of any one of embodiments 1 to 16, wherein (i) an outer perimeter portion 110 of said inlet face 11 is within an inlet face plane 111, (ii) an outer perimeter portion 142 of said outlet face 14 is within an outlet face plane 144, (iii) said inlet face plane 111 is substantially parallel to said outlet face plane 144, and (iv) at least a portion of said outlet face 141/145 is above said outlet face plane 144.
18. The nozzle 10 of any one of embodiments 1 to 17, wherein (i) an outer perimeter portion 110 of said inlet face 11 is within an inlet face plane 111, (ii) an outer perimeter portion 142 of said outlet face 14 is within an outlet face plane 144, (iii) said inlet face plane 111 is substantially parallel to said outlet face plane 144, (iv) at least a portion of said outlet face 141/145 is above said outlet face plane 144, and (v) a vertically-extending portion 145 of said outlet face 14 separates a lower planar portion 142 of said outlet face 14, within said outlet face plane 144, from an uppermost portion 141 of said outlet face 14.
19. The nozzle 10 of any one of embodiments 1 to 18, wherein said inlet face 11 comprises (i) an outer perimeter portion 110 of said inlet face 11 is within an inlet face plane 111, (ii) an outer perpendicular wall portion 27 extending upward from said outer perimeter portion 110 within said inlet face plane 111, (iii) an intermediate wall portion 13/18 extending from said outer perpendicular wall portion 27, at least a portion of said intermediate wall portion 13/18 representing said second inlet surface 13, (iv) an inner perpendicular wall portion 17 extending upward from said intermediate wall portion 13/18, and (v) an uppermost portion 12, at least a portion of said uppermost portion 12 representing said first inlet surface 12.
20. The nozzle 10 of any one of embodiments 1 to 19, wherein said first inlet surface 12 has a first surface radius of curvature of greater than about 10 μm (or any radius of curvature up to about 4 m, or any value or range of values between 10 μm and 4 m, in increments of 1.0 μm).

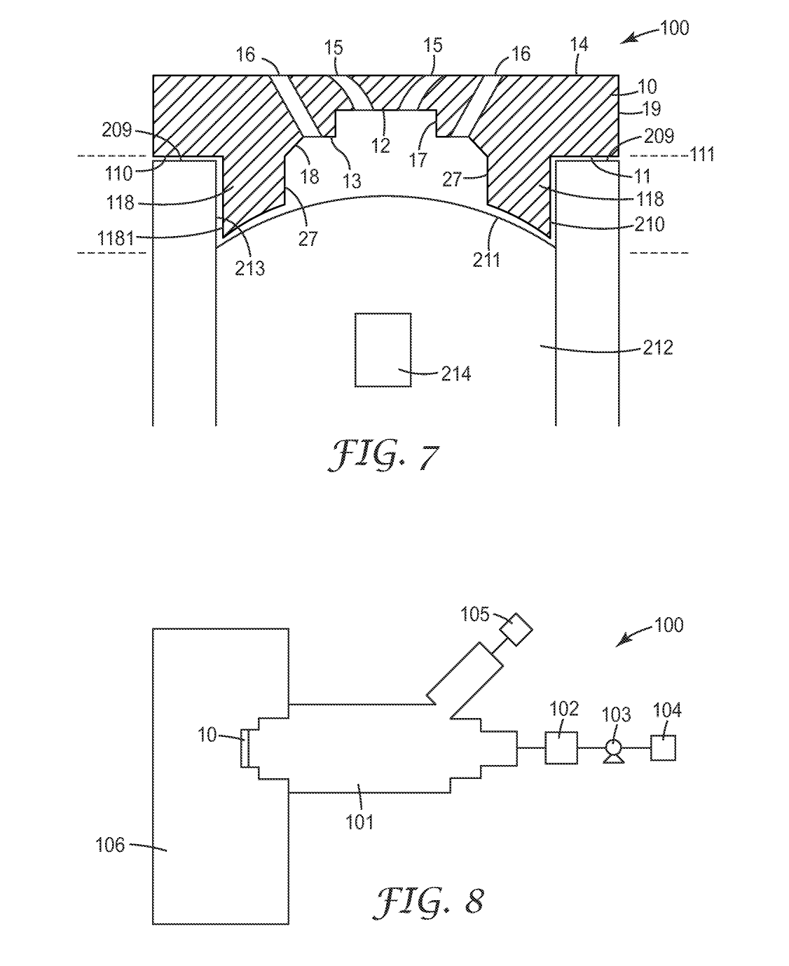

21. The nozzle 10 of any one of embodiments 1 to 20, wherein said second inlet surface 13 has a second surface radius of curvature of greater than about 10 μm (or any radius of curvature up to about 4 m, or any value or range of values between 10 μm and 4 m, in increments of 1.0 μm).
22. The nozzle 10 of any one of embodiments 1 to 19, wherein said first inlet surface 12 of said inlet face 11 has a relatively flat surface profile.
23. The nozzle 10 of embodiment 19 or 22, wherein said first inlet surface 12 of said inlet face 11 is within an uppermost inlet surface plane 121, said uppermost inlet surface plane 121 being substantially parallel to said inlet face plane 111.
24. The nozzle 10 of any one of embodiments 1 to 23, wherein said first inlet surface 12 of said inlet face 11 is below a lowermost portion 142 of said outlet face 14.
25. The nozzle 10 of any one of embodiments 1 to 23, wherein at least a portion of said first inlet surface 12 of said inlet face 11 is above at least a portion of said outlet face 14.
26. The nozzle 10 of any one of embodiments 11 to 25, wherein at least a portion of said intermediate wall portion 13/18 of said inlet face 11 has a relatively flat surface profile, said portion comprising said second inlet surface 13.
27. The nozzle 10 of embodiment 26, wherein said portion of said intermediate wall portion 13/18 is within an intermediate inlet surface plane 131, said intermediate inlet surface plane 131 being substantially parallel to said inlet face plane 111.
28. The nozzle 10 of embodiment 26 or 27, wherein said portion of said intermediate wall portion 13/18 is below said outlet face 14.
29. The nozzle 10 of embodiment 26 or 27, wherein said portion of said intermediate wall portion 13/18 is above at least a portion of said outlet face 14.
30. The nozzle 10 of any one of embodiments 1 to 29, wherein at least one outlet opening 152/162 is positioned along a lower planar portion 142 of said outlet face 14.
31. The nozzle 10 of any one of embodiments 1 to 30, wherein at least one outlet opening 152/162 is positioned along a vertically-extending portion 145 of said outlet face 14.
32. The nozzle 10 of any one of embodiments 1 to 31, wherein at least one outlet opening 152/162 is positioned along an uppermost portion 141 of said outlet face 14.
33. The nozzle 10 of embodiment 31 or 32, wherein said vertically-extending portion 145 of said outlet face 14 forms (i) a first angle P with said lower planar portion 142 of said outlet face 14 ranging from about 90° to less than about 165° (or any angle or range of angle values between 90° and 165° in increments of 1°), and (ii) a second angle Q with said uppermost portion 141 of said outlet face 14 of from about 90° to less than about 165° (or any angle or range of angle values between 90° and 165° in increments of 1°).
34. The nozzle 10 of any one of embodiments 31 to 33, wherein said vertically-extending portion 145 of said outlet face 14 forms (i) a first angle P with said lower planar portion 142 of said outlet surface 14 ranging from about 90° to about 135° (or any angle or range of angle values between 90° and 135° in increments of 1°), and (ii) a second angle Q with said uppermost portion 141 of said outlet face 14 of about 90° to about 135° (or any angle or range of angle values between 90° and 135° in increments of 1°).
35. The nozzle 10 of any one of any one of embodiments 31 to 34, wherein said vertically-extending portion 145 of said outlet face 14 forms (i) a first angle P with said lower planar portion 142 of said outlet face 14 of about 135°, and (ii) a second angle Q with said uppermost portion 141 of said outlet face 14 of about 135°.
36. The nozzle 10 of any one of any one of embodiments 31 to 34, wherein said vertically-extending portion 145 of said outlet face 14 forms (i) a first angle P with said lower planar portion 142 of said outlet face 14 of about 90°, and (ii) a second angle Q with said uppermost portion 141 of said outlet face 14 of from about 90°.
37. The nozzle 10 of any one of embodiments 31 to 36, wherein said vertically-extending portion 145 of said outlet face 14 comprises a relatively flat surface 146 (i.e., no curve) between said lower planar portion 142 of said outlet face 14 and said uppermost portion 141 of said outlet face 14.
38. The nozzle 10 of any one of embodiments 31 to 37, wherein said vertically-extending portion 145 of said outlet face 14 has a cylindrical or truncated cone surface profile extending between said lower planar portion 141 of said outlet face 14 and said uppermost portion 141 of said outlet face 14.
39. The nozzle 10 of any one of embodiments 1 to 38, wherein (a) at least one outlet opening 152 of said first nozzle through-holes 15 is positioned along a lower planar portion 142 of said outlet face 14, and (b) at least one outlet opening 162 of said second nozzle through-holes 16 is positioned along said lower planar portion 141 of said outlet face 14.
40. The nozzle 10 of any one of embodiments 1 to 38, wherein (a) at least one outlet opening 152 of said first nozzle through-holes 15 is positioned along a vertically-extending portion 145 of said outlet face 14, and (b) at least one outlet opening 162 of said one or more second nozzle through-holes 16 is positioned along a lower planar portion 142 of said outlet face 14.
41. The nozzle 10 of any one of embodiments 1 to 38, wherein (a) at least one outlet opening 152 of said one or more first nozzle through-holes 15 is positioned along a vertically-extending portion 145 of said outlet face 14, and (b) at least one outlet opening 162 of said one or more second nozzle through-holes 16 is positioned along said vertically-extending portion 145 of said outlet face 14.
42. The nozzle 10 of embodiment 41, wherein said at least one outlet opening 152 of said one or more first nozzle through-holes 15 is positioned along an upper portion 147 of said vertically-extending portion 145 of said outlet face 14, and said at least one outlet opening 162 of said one or more second nozzle through-holes 16 is positioned along a lower portion 148 of said vertically-extending portion 145 of said outlet face 14.
43. The nozzle 10 of any one of embodiments 1 to 38, wherein (a) at least one outlet opening 152 of said one or more first nozzle through-holes 15 is positioned along an uppermost portion 141 of said outlet face 14, and (b) at least one outlet opening 162 of said one or more second nozzle through-holes 16 is positioned along a lower planar portion 142 of said outlet face 14.
44. The nozzle 10 of embodiment 43, wherein said at least one outlet opening 162 of said one or more second nozzle through-holes 16 is positioned so as to direct fluid (not shown) exiting said at least one outlet opening 162 towards said vertically-extending portion 145 of said outlet face 14 so as to contact said vertically-extending portion 145.
45. The nozzle 10 of any one of embodiments 1 to 44, wherein (1) each of said one or more first nozzle through-holes 15 has a first internal surface profile extending directly from a first nozzle inlet opening 151 to a first nozzle outlet opening 152 and a second internal surface profile extending directly from the first nozzle inlet opening 151 to the first nozzle outlet opening 152, said second internal surface profile of said first nozzle through-hole 15 being (i) on an opposite side of a first nozzle cavity 153 from said first internal surface profile of each said first nozzle through-hole 15 and (ii) closer to a central normal line 20 perpendicular to an outer periphery 19 of said nozzle 10; (2) each of said one or more second nozzle through-holes 16 has a first internal surface profile extending directly from a second nozzle inlet opening 161 to a second nozzle outlet opening 162 and a second internal surface profile extending directly from the second nozzle inlet opening 161 to the second nozzle outlet opening 162, said second internal surface profile of each said second nozzle through-hole 16 being (i) on an opposite side of a second nozzle cavity 163 from said first internal surface profile of said second nozzle through-hole 16 and (ii) closer to the central normal line 20 perpendicular to the outer periphery 19 of said nozzle 10; and (3) each of said first internal surface profile of said first nozzle through-hole 15, said second internal surface profile of said first nozzle through-hole 15, said first internal surface profile of said second nozzle through-hole 16 and said second internal surface profile of said second nozzle through-hole 16 is independently either has a surface profile with or without curvature.
46. The nozzle 10 of embodiment 45, wherein said first internal surface portion of said first nozzle through-hole 15 has a relatively flat surface profile (extending directly from inlet opening 151 to outlet opening 152), and said second internal surface portion of said first nozzle through-hole 15 has a curved surface profile (extending directly from inlet opening 151 to outlet opening 152).
47. The nozzle 10 of embodiment 45, wherein said first internal surface portion of said first nozzle through-hole 15 has a surface profile with a first degree of curvature (extending directly from inlet opening 151 to outlet opening 152), said second internal surface portion of said first nozzle through-hole 15 has a surface profile with a second degree of curvature (extending directly from inlet opening 151 to outlet opening 152), and said second degree of curvature is greater than said first degree of curvature.
48. The nozzle 10 of any one of embodiments 45 to 47, wherein said first internal surface portion of said second nozzle through-hole 16 has a relatively flat surface profile (extending directly from inlet opening 151 to outlet opening 152), and said second internal surface portion of said second nozzle through-hole 16 has a relatively flat surface profile (extending directly from inlet opening 151 to outlet opening 152).
49. The nozzle 10 of any one of embodiments 45 to 47, wherein said first internal surface portion of said second nozzle through-hole 16 has a relatively flat surface profile (extending directly from inlet opening 151 to outlet opening 152), and said second internal surface portion of said second nozzle through-hole 16 has a curved surface profile (extending directly from inlet opening 151 to outlet opening 152).
50. The nozzle 10 of any one of embodiments 45 to 47, wherein said first internal surface portion of said second nozzle through-hole 16 has a surface profile with a first degree of curvature (extending directly from inlet opening 151 to outlet opening 152), said second internal surface portion of said second nozzle through-hole 16 has a surface profile with a second degree of curvature (extending directly from inlet opening 151 to outlet opening 152), and said second degree of curvature is greater than said first degree of curvature.
51. The nozzle 10 of any one of embodiments 45 to 47, wherein said second internal surface portion of said second nozzle through-hole 16 has a relatively flat surface profile (extending directly from inlet opening 151 to outlet opening 152), and said first internal surface portion of said second nozzle through-hole 16 has a curved surface profile (extending directly from inlet opening 151 to outlet opening 152).
52. The nozzle 10 of any one of embodiments 45 to 47, wherein said first internal surface portion of said second nozzle through-hole 16 has a surface profile with a first degree of curvature (extending directly from inlet opening 151 to outlet opening 152), said second internal surface portion of said second nozzle through-hole 16 has a surface profile with a second degree of curvature (extending directly from inlet opening 151 to outlet opening 152), and said first degree of curvature is greater than said second degree of curvature.
53. The nozzle 10 of any one of embodiments 1 to 52, wherein each of (i) said one or more first nozzle through-holes 15 and (ii) said one or more second nozzle through-holes 16 independently comprises two or more nozzle through-holes (or any number or range of numbers of nozzle through-holes greater than two in increments of 1).
54. The nozzle 10 of any one of embodiments 1 to 53, wherein each of (i) said one or more first nozzle through-holes 15 and (ii) said one or more second nozzle through-holes 16 independently comprises from about 4 to about 24 nozzle through-holes (or any number or range of numbers between 4 and 24 in increments of 1).
55. The nozzle 10 of any one of embodiments 1 to 54, wherein said nozzle 10 comprises one or more overlapping outer surface portions 149 (see, FIG. 5) along said outlet face 14.
56. The nozzle 10 of any one of embodiments 1 to 55, wherein said outlet face 14 further comprises anti-coking nanostructures 150 thereon.
57. The nozzle 10 of embodiment 56, wherein said anti-coking nanostructures 150 are present along one or more portions of said outlet face 14, said one or more portions of said outlet face 14 comprising (i) an upper surface 141 of one or more overlapping outer surface portions 149 of said outlet face 14, when present, (ii) a lower planar portion 142 of said outlet face 10, (iii) an uppermost portion 141 of said outlet face 14, (iv) a vertically-extending portion 145 of said outlet face 14 between said lower planar portion 142 of said outlet face 14 and said uppermost portion 141 of said outlet face 14, or (v) any combination of (i) to (iv).
58. The nozzle 10 of any one of embodiments 1 to 57, wherein at least one inlet opening 151/161 and at least one outlet opening 152/162 of at least one nozzle through-hole 15/16 have a similar shape.
59. The nozzle 10 of any one of embodiments 1 to 58, wherein at least one inlet opening 151/161 and at least one outlet opening 152/162 of at least one nozzle through-hole 15/16 have a different shape.
60. The nozzle 10 of any one of embodiments 1 to 59, wherein said nozzle 10 further comprises an inlet surface with one or more inlet face features 118 that extend into a ball valve outlet region 210 of a fuel injector system 100 to further reduce a SAC volume of the fuel injector system 100 when said nozzle 10 is placed in contact with a ball valve 212 outlet (also referred to herein as fuel injector tip 209) of the fuel injector system 100. It can be desirable, in addition or alternatively, for the inlet surface of the nozzle to match, preferably so as to mate and/or seal with, the outer surface of the ball valve. “SAC volume” is defined as a volume of space between an inlet face of a fuel injector nozzle (i.e., inlet face 11 of nozzle 10) and an outer surface 211 of a ball valve 212 of a fuel injector system 100. See, for example, FIG. 7 of the present invention.

Typically, the SAC volume is represented by a volume of space outlined by a line extending between fuel injector tips 209 and outer surface 211 of a ball valve 212 of a fuel injector system 100 given that most nozzles, including most embodiments of nozzle 10, do not comprise any inlet face features 118 that extend into a ball valve outlet region 210; however, as shown in FIG. 7 of the present invention, in some embodiments, nozzle 10 does comprise inlet face features 118 that extend into a ball valve outlet region 210). In some embodiments, the SAC volume of a given fuel injector 101 can be reduced up to about 50% or more (or any percent up to 50% in increments of 1%).
61. The nozzle 10 of embodiment 55, wherein a portion of said inlet face 110 is within an inlet face plane 111 and extends along an outer perimeter of said inlet face 11, and said one or more inlet face features 118 comprise a tubular-shaped member 118 having an outer circular side wall 1181 that abuts or is positioned adjacent to an inner side wall surface 213 of the ball valve outlet region 210.
62. The nozzle 10 of any one of embodiments 1 to 61, wherein said nozzle 10 further comprises one or more fluid impingement members 1519 positioned along said outlet face 14.
63. The nozzle of embodiment 62, wherein said one or more fluid impingement members 1519 are present along one or more portions of said outlet face 14, said one or more portions of said outlet face 14 comprising (i) a surface 159/159′ of one or more overlapping outer surface portions 149 of said outlet face 14, when present, (ii) a lower planar portion 142 of said outlet face 14, (iii) an uppermost portion 141 of said outlet face 14, (iv) a vertically-extending portion 145 of said outlet face 14 between said lower planar portion 142 of said outlet face 14 and said uppermost portion 141 of said outlet face 14, or (v) any combination of (i) to (iv).
64. The nozzle 10 of any one of embodiments 1 to 63, wherein each inlet opening 151/161 has a diameter of less than about 400 microns (or less than about 300 microns, or less than about 200 microns, or less than about 160 microns, or less than about 100 microns) (or any diameter between about 10 microns and 400 microns in increments of 1.0 micron, e.g., 10, 11, 12, etc. microns).
65. The nozzle 10 of any one of embodiments 1 to 64, wherein each outlet opening 152/162 has a diameter of less than about 400 microns (or less than about 300 microns, or less than about 200 microns, or less than about 100 microns, or less than about 50 microns, or less than about 20 microns) (or any diameter between about 10 microns and 400 microns in increments of 1.0 micron, e.g., 10, 11, 12, etc. microns).
66. The nozzle 10 of any one of embodiments 1 to 65, wherein the nozzle 10 comprises a metallic material, an inorganic non-metallic material (e.g., a ceramic), or a combination thereof.
67. The nozzle 10 of any one of embodiments 1 to 66, wherein the nozzle 10 comprises a ceramic selected from the group comprising silica, zirconia, alumina, titania, or oxides of yttrium, strontium, barium, hafnium, niobium, tantalum, tungsten, bismuth, molybdenum, tin, zinc, lanthanide elements having atomic numbers ranging from 57 to 71, cerium and combinations thereof.
68. The nozzle 10 of any one of embodiments 1 to 67, wherein the nozzle 10 comprises a monolithic structure. As used herein, the term “monolithic” refers to a nozzle having a single, integrally formed structure, as oppose to multiple parts or components being combined with one another to form a nozzle.
69. The nozzle 10 of any one of embodiments 1 to 68 in combination with a fuel injector valve 80, said fuel injector valve 80 having a fuel injector valve contact surface 81, at least a portion of which is operatively adapted (e g , dimensioned, configured or otherwise designed) and sized to extend along a perpendicular wall 17 of said inlet face 11 that is closest to a nozzle plate central axis 20 extending along a normal line perpendicular to an outer periphery 19 of said nozzle 10.

### Fuel Injector Embodiments

70. A fuel injector 101 comprising the nozzle 10 of any one of embodiments 1 to 69.

### Fuel Injector Systems Embodiments

71. A fuel injection system 100 of a vehicle 200 comprising the fuel injector 101 of embodiment 70.
72. A fuel injection system 100 of a vehicle 200 comprising: a nozzle 10 comprising a non-coined three-dimensional inlet face 11 comprising a first inlet surface 12 and a second inlet surface 13; an outlet face 14 opposite said inlet face 11; and one or more first nozzle through-holes 15 and one or more second nozzle through-holes 16, with each said first nozzle through-hole 15 comprising at least one inlet opening 151 on said first inlet surface 12 connected to at least one outlet opening 152 on said outlet face 14 by a cavity 153 defined by an interior surface 154, and each said second nozzle through-hole 16 comprising at least one inlet opening 161 on said second inlet surface 13 connected to at least one outlet opening 162 on said outlet face 14 by a cavity 163 defined by an interior surface 164, wherein said first inlet surface 12 is not coplanar with said second inlet surface 13; and a fuel injector valve 80 having a fuel injector valve contact surface 81; wherein said fuel injection system 100 provides at least three levels of fluid flow through said nozzle 10 depending on a position of said fuel injector valve 80 relative to said nozzle 10.
73. The fuel injection system 100 of embodiment 72, wherein said nozzle 10 comprises the nozzle 10 of any one of embodiments 1 to 69.
74. The fuel injection system 100 of embodiment 72 or 73, further comprising a device 214 (e.g., a solenoid valve) that controls a position of said fuel injector valve 80 relative to said nozzle 10.
75. The fuel injection system 100 of any one of embodiments 72 to 74, wherein the at least three levels of fluid flow through said nozzle 10 comprise (1) no fluid flow; (2) partial fluid flow, wherein fluid flows through said one or more second nozzle through-holes 16; and (3) full fluid flow, wherein fluid flows through said one or more first nozzle through-holes 15 and said one or more second nozzle through-holes 16.

### Methods of Making Nozzles Embodiments

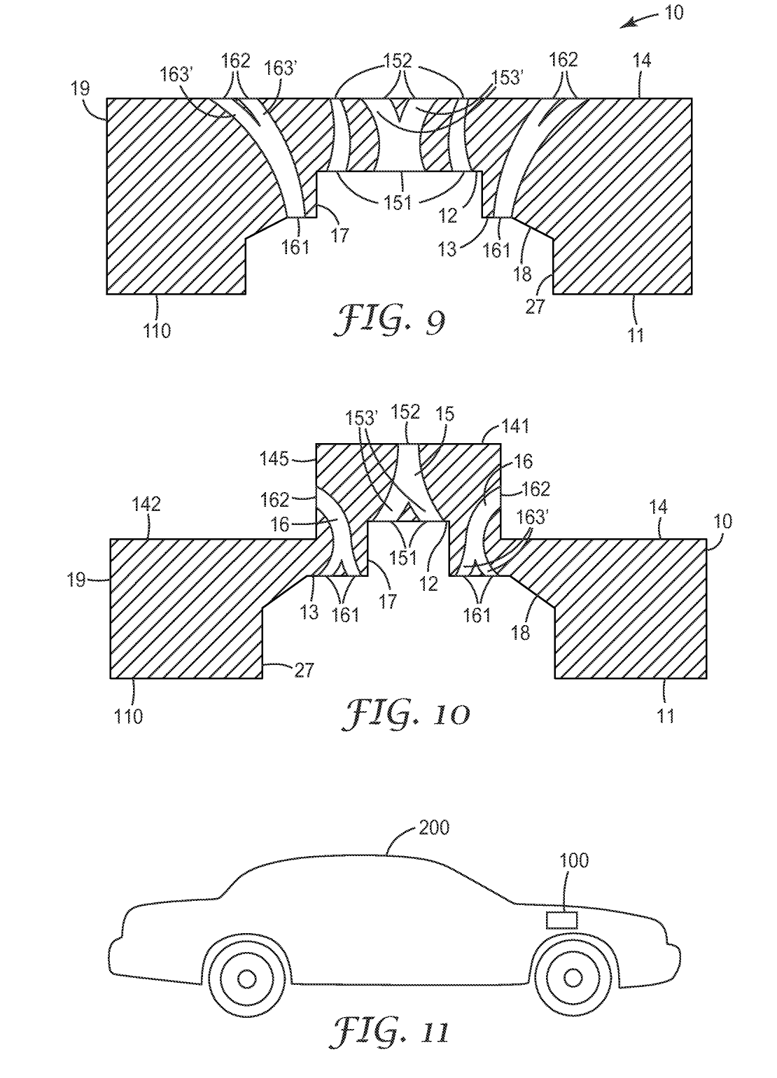

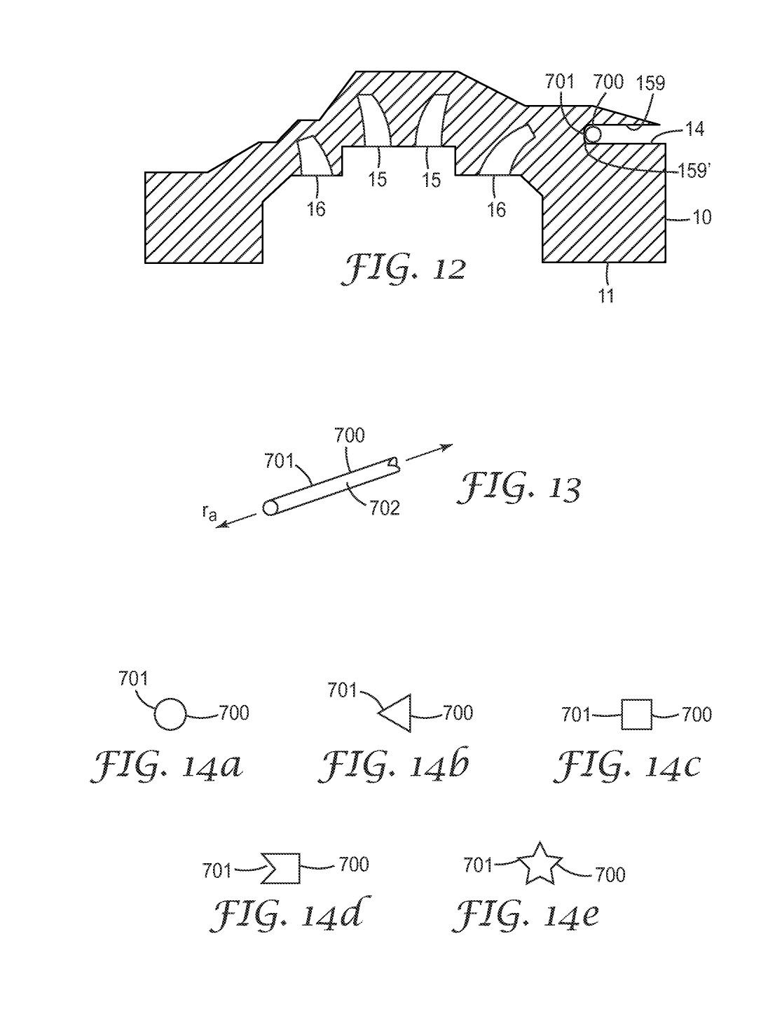

76. A method of making the nozzle 10 of any one of embodiments 1 to 69.
77. A method of making a fuel injector nozzle 10, said method comprising: forming a nozzle 10 comprising a non-coined three-dimensional inlet face 11 comprising a first inlet surface 12 and a second inlet surface 13; an outlet face 14 opposite the inlet face 11; and one or more first nozzle through-holes 15 and one or more second nozzle through-holes 16, with each first nozzle through-hole 15 comprising at least one inlet opening 151 on the first inlet surface 12 connected to at least one outlet opening 152 on the outlet face 14 by a cavity 153 defined by an interior surface 154, and each second nozzle through-hole 16 comprising at least one inlet opening 161 on the second inlet surface 13 connected to at least one outlet opening 162 on the outlet face 14 by a cavity 163 defined by an interior surface 164, wherein the first inlet surface 12 is not coplanar with the second inlet surface 13.
78. A method of making a fuel injector nozzle 10, said method comprising: forming a nozzle 10 comprising a non-coined three-dimensional inlet face 11 comprising a first inlet surface 12 and a second inlet surface 13; an outlet face 14 opposite the inlet face 11; and one or more first nozzle through-holes 15 and one or more second nozzle through-holes 16, with each first nozzle through-hole 15 comprising at least one inlet opening 151 on the first inlet surface 12 connected to at least one outlet opening 152 on the outlet face 14 by a cavity 153 defined by an interior surface 154, and each second nozzle through-hole 16 comprising at least one inlet opening 161 on the second inlet surface 13 connected to at least one outlet opening 162 on the outlet face 14 by a cavity 163 defined by an interior surface 164, wherein a perpendicular wall portion 17 of the inlet face 11 separates (i) at least one inlet opening 151 of the one or more first nozzle through-holes 15 from (ii) at least one inlet opening 161 of the one or more second nozzle through-holes 16.
79. The method of embodiment 77 or 78, wherein said step of forming the inlet face 11 comprises forming two concentrically-oriented perpendicular wall portions 17/27 along the inlet face 11.
80. The method of embodiment 79, wherein each perpendicular wall portion 17/27 has a circular cross-sectional configuration (or square, or triangular, or oval, or star, or any other polygon shape) as viewed along a nozzle plate central axis 20 extending along a normal line perpendicular to an outer periphery 19 of the nozzle 10.
81. The method of embodiment 79 or 80, wherein each perpendicular wall portion 17/27 of the inlet face 11 is substantially parallel to a nozzle central axis 20 extending along a normal line perpendicular to an outer periphery 19 of the nozzle 10.
82. The method of any one of embodiments 77 to 81, wherein (i) an outer periphery portion 110 of the inlet face 11 is within an inlet face plane 111, (ii) an outer periphery portion 142 of an outlet face 14 of the nozzle 10 is within an outlet face plane 144, and (iii) the inlet face plane 111 is substantially parallel to the outlet face plane 144.
83. The method of any one of embodiments 77 to 82, wherein (i) an outer periphery portion 110 of the inlet face 11 is within an inlet face plane 111, (ii) an outer periphery portion 142 of an outlet face 14 of the nozzle 10 is within an outlet face plane 144, (iii) the inlet face plane 111 is substantially parallel to the outlet face plane 144, and (iv) at least a portion of the outlet face 145/141 is above the outlet face plane 144.
84. The method of any one of embodiments 77 to 83, wherein (i) an outer periphery portion 110 of the inlet face 11 is within an inlet face plane 111, (ii) an outer periphery portion 142 of an outlet face 14 of the nozzle 10 is within an outlet face plane 144, (iii) the inlet face plane 111 is substantially parallel to the outlet face plane 144, (iv) at least a portion of the outlet face 145/141 is above the outlet face plane 144, and (v) a vertically-extending portion 145 of the outlet face 14 separates a lower planar portion 142 of the outlet face 14 within the outlet face plane 144, from an uppermost portion 141 of the outlet face 14.
85. The method of any one of embodiments 77 to 84, wherein the inlet face 11 comprises (i) an outer periphery portion 110 within an inlet face plane 111 and adjacent an outer periphery 19 of the nozzle 10, (ii) an outer perpendicular wall portion 27 extending upward from the outer periphery portion 110 of the inlet face 11 within the inlet face plane 111, (iii) an intermediate wall portion 18/13 extending from the outer perpendicular wall portion 27 of the inlet face 11, at least a portion of which comprises the second inlet surface 13, (iv) an inner perpendicular wall portion 17 of the inlet face 11 extending upward from the intermediate wall portion 18/13, and (v) an uppermost portion 12 of the inlet face 11, at least a portion of which comprises the first inlet surface 12.
86. The method of embodiment 85, wherein the uppermost portion 12 of the inlet face 11 has a relatively flat surface profile.
87. The method of embodiment 85 or 86, wherein the uppermost portion 12 of the inlet face 11 is within an uppermost inlet face plane 121, the uppermost inlet face plane 121 being substantially parallel to the inlet face plane 111.
88. The method of any one of embodiments 77 to 87, wherein at least a portion of an intermediate wall portion 18/13 of the inlet face 11 that extends between perpendicular wall portions 27/17 of the inlet face 11 has a relatively flat surface profile.
89. The method of embodiment 88, wherein the portion of the intermediate wall portion 18/13 is within an intermediate inlet face plane 131, and the intermediate inlet face plane 131 is substantially parallel to an inlet face plane 111.
90. The method of any one of embodiments 77 to 89, wherein said step of forming the nozzle 10 comprises forming at least one outlet opening 152/162 along a lower planar portion 142 of the outlet face 14.
91. The method of any one of embodiments 77 to 90, wherein said step of forming the nozzle 10 comprises forming at least one outlet opening 152/162 along a vertically-extending portion 145 of the outlet face 14.
92. The method of any one of embodiments 77 to 91, wherein said step of forming the nozzle 10 comprises forming at least one outlet opening 152/162 along an uppermost portion 141 of the outlet face 14.
93. The method of any one of embodiments 77 to 92, further comprising: forming a three-dimensional outlet face 14 on the nozzle 10.
94. The method of any one of embodiments 77 to 93, further comprising: forming a three-dimensional outlet face 14 on the nozzle 10, the three-dimensional outlet face 14 having a cylindrical or truncated cone surface profile (i.e., surface 145) extending between a lower planar portion 141 of the outlet face 14 and an uppermost portion 141 of the outlet face 14.
95. The method of any one of embodiments 77 to 94, wherein said step of forming the nozzle 10 comprises forming (a) at least one outlet opening 162 of the one or more second nozzle through-holes 16 along a lower planar portion 141 of the outlet face 14, and (b) at least one outlet opening 152 of the one or more first nozzle through-holes 15 along the lower planar portion 141 of the outlet surface 14.
96. The method of any one of embodiments 77 to 94, wherein said step of forming the nozzle 10 comprises forming (a) at least one outlet opening 162 of the one or more second nozzle through-holes 16 along a lower planar portion 141 of the outlet face 14, and (b) at least one outlet opening 152 of the one or more first nozzle through-holes 15 along a vertically-extending portion 145 of the outlet face 14.
97. The method of any one of embodiments 77 to 94, wherein said step of forming the nozzle 10 comprises forming (a) at least one outlet opening 162 of the one or more second nozzle through-holes 16 along a vertically-extending portion 145 of the outlet surface 14, and (b) at least one outlet opening 152 of the one or more first nozzle through-holes 15 along the vertically-extending portion 145 of the outlet surface 14.
98. The method of embodiment 97, wherein the at least one outlet opening 162 of the one or more second nozzle through-holes 16 is positioned along a lower portion 148 of the vertically-extending portion 145 of the outlet face 14, and the at least one outlet opening 152 of the one or more first nozzle through-holes 15 is positioned along an upper portion 147 of the vertically-extending portion 145 of the outlet face 14.
99. The method of any one of embodiments 77 to 94, wherein said step of forming the nozzle 10 comprises forming (a) at least one outlet opening 162 of the one or more second nozzle through-holes 16 along a lower planar portion 141 of the outlet face 14, and (b) at least one outlet opening 152 of the one or more first nozzle through-holes 15 along an uppermost portion 141 of the outlet face 14.
100. The method of embodiment 99, wherein the at least one outlet opening 162 of the one or more second nozzle through-holes 16 is positioned so as to direct fluid (not shown) exiting the at least one outlet opening 162 towards the vertically-extending portion 145 of the outlet face 14 so as to contact the vertically-extending portion 145 of the outlet face 14.
101. The method of any one of embodiments 77 to 100, wherein said step of forming the nozzle 10 comprises forming one or more nozzle through-holes 15/16 that independently comprise two or more outlet openings 152/162.
102. The method of embodiment 101, wherein the two or more outlet openings 152/162 comprises from about 2 to about 24 outlet openings 152/162 (or any number or range of numbers between 2 and 24 in increments of 1).
103. The method of any one of embodiments 77 to 102, wherein said step of forming the nozzle 10 comprises forming one or more nozzle through-holes 15/16 having multiple cavity passages 153′/163′ extending along a length of the cavity 153/163. See, for example, FIG. 9, which depicts individual nozzle through-holes 15/16 comprising (i) single inlet openings 151/161, (ii) multiple outlet openings 152/162, and (iii) multiple cavity passages 153′/163′ extending along a length of cavity 153/163. As shown in FIG. 10, in other embodiments, individual nozzle through-holes 15/16 comprise (i) multiple inlet openings 151/161, (ii) single outlet openings 152/162, and (iii) multiple cavity passages 153′/163′ extending along a length of cavity 153/163.
104. The method of any one of embodiments 77 to 103, wherein said step of forming the nozzle 10 comprises forming two or more nozzle through-holes 15/16 in each of (i) the one or more first nozzle through-holes 15 and (ii) the one or more second nozzle through-holes 16.
105. The method of embodiment 104, wherein the two or more nozzle through-holes 15/16 of (i) the one or more first nozzle through-holes 15 and (ii) the one or more second nozzle through-holes 15 each independently comprise from about 4 to about 24 nozzle through-holes 15/16 (or any number or range of numbers between 4 and 24 in increments of 1).
106. The method of any one of embodiments 77 to 105, said method further comprising: forming one or more overlapping outer surface portions 149 along the outlet face 14 of the nozzle 10.
107. The method of any one of embodiments 77 to 106, said method further comprising: forming anti-coking nanostructures 150 along one or more portions of the outlet face 14 of the nozzle 10, the one or more portions of the outlet face 14 comprising (i) an upper surface 141 of one or more overlapping outer surface portions 149 of the outlet face 14, when present, (ii) a lower planar portion 142 of the outlet face 14, (iii) an uppermost portion 141 of the outlet face 14, (iv) a vertically-extending portion 145 of the outlet face 14 between the lower planar portion 142 of the outlet face 14 and the uppermost portion 141 of the outlet face 14, or (v) any combination of (i) to (iv).
108. The method of any one of embodiments 77 to 107, said method further comprising: forming one or more fluid impingement members 1519 positioned along one or more portions of the outlet face 14 of the nozzle 10, the one or more portions of the outlet face 14 comprising (i) a surface 141/159 of one or more overlapping outer surface portions 149 of the outlet face 14, when present, (ii) a lower planar portion 142 of the outlet face 14, (iii) an uppermost portion 141 of the outlet face 14, (iv) a vertically-extending portion 145 of the outlet face 14 between the lower planar portion 142 of the outlet face 14 and the uppermost portion 141 of the outlet face 14, or (v) any combination of (i) to (iv).
109. The method of any one of embodiments 77 to 108, further comprising: removing material from a side surface of a nozzle 10 so as to form one or more outlet face features 149/150/151 along the outlet face 14 of the nozzle 10.
110. The method of embodiment 109, wherein said removing step comprises contacting the nozzle 10 with a contacting surface 701 (i.e., a lead contacting surface 701 along an outer surface 702) of a tool 700, the contacting surface 701 of the tool 700 providing at least one of the following outlet face features: (1) an overlapping outer surface profile 159/159′ for each overlapping outer surface portion 149, when present, (2) at least one vertically-extending wall portion 145 along the outer face 14, (3) one or more impingement members 151, (4) anti-coking structures 150, and (5) one or more outlet openings 152/162.
111. The method of embodiment 109 or 110, wherein said removing step comprises removing material from the nozzle 10 with a surface 701 of a tool 700, the surface 701 of the tool 700 comprising a single continuous surface (e.g., an arc-shaped surface) having a circular cross-sectional configuration (e.g., tool 701 shown in FIGS. 12-13). The tool 700 can be the type, for example, that contacts and abrasively removes nozzle material, or it can be the type that removes material without actual contact (e.g., the electrode of an electric discharge machine or EDM). As shown in FIGS. 14-16, tool 700 may have any desired cross-sectional configuration as shown in FIGS. 14a-e, which results in various outlet surface 14 features including, but not limited to, a desired overlapping outer surface profile 159/159′ for a given overlapping outer surface portion 149 as shown in FIGS. 15a-e, anti-coking microstructures 150 (as shown in FIG. 5), impingement members 1519 as shown in FIG. 6, and other outlet face 14 surface undulations (not shown). In some embodiments, tool 700 may be rotated along its axis, rₐ, to further provide surface features to outlet face 14 (e.g., when tool 700 has a star-shaped cross-sectional configuration, as shown in FIG. 14e, and is rotated along is axis while removing material from nozzle 10, so as to result in an outlet face 14 features shown in FIG. 15e). Further, tool 700 have further comprise one or more tool surface features 704 that may be used (either with or without rotation along its axis, rₐ) to further provide outlet face 14 features on nozzle 10.
112. The method of embodiment 109 or 110, wherein said removing step comprises contacting the nozzle 10 with a contacting surface 701 of a tool 700, the contacting surface 701 of the tool 700 comprising a wedge-shaped member 700 having a wedge edge 701 (as shown in FIG. 14b) that initially contacts the nozzle 10.
113. The method of embodiment 109 or 110, wherein said removing step comprises contacting the nozzle 10 with a contacting surface 701 of a tool 700, the contacting surface 701 of the tool 700 comprising three or more connected surfaces 701 (e.g., tool 700 shown in FIGS. 14c-e) so as to form (i) an upper overlapping outer surface portion 159, (ii) a lower overlapping outer surface portion 145, and (iii) one or more intermediate outer surface portions 159′ connecting the upper and lower overlapping outer surface portions 159/145 along the nozzle 10.
114. The method of any one of embodiments 109 to 113, wherein said removing step further comprises forming one or more outlet openings 152/162 of one or more nozzle through-holes 15/16.
115. The method of any one of embodiments 109 to 114, wherein said removing step comprises an electric discharge machining (EDM) step.
116. The method of any one of embodiments 109 to 115, wherein said removing step comprises a wire-EDM step.
117. The method of any one of embodiments 109 to 115, wherein said removing step comprises a sinker-EDM step.
118. The method of any one of embodiments 77 to 117, wherein said step of forming nozzle 10 comprises: fabricating a nozzle forming microstructured pattern used to form a nozzle pre-form; applying a nozzle-forming material over the nozzle forming microstructured pattern comprising one or more nozzle hole forming features; separating the nozzle-forming material from the nozzle forming microstructured pattern to provide the nozzle 10; and removing material, as needed, from the nozzle 10 to form one or more nozzle through-holes 15/16. See, for example, FIGS. 1A-1M and the description thereof in International Patent Application Serial No. US2012/023624.
119. The method of embodiment 118, wherein said fabricating step comprises a two-photon polymerization step. For a description of a two-photon polymerization step suitable for forming nozzle 10 of the present invention, see FIGS. 1A-1M and the description thereof in International Patent Application Serial No. US2012/023624.

### Methods of Making Fuel Injection Systems Embodiments

120. A method of forming a fuel injection system 100 of a vehicle 200, said method comprising incorporating the nozzle 10 of any one of embodiments 1 to 68 into the fuel injection system 100.

### Nozzle Pre-Form Embodiments

121. A nozzle pre-form suitable for forming the nozzle 10 of any one of embodiments 1 to 68.See, for example, other nozzle pre-forms and how the nozzle pre-forms are utilized to form nozzles in FIGS. 1A-1M and the description thereof in International Patent Application Serial No. US2012/023624.

### Microstructured Pattern Embodiments

122. A microstructured pattern suitable for forming the nozzle 10 of any one of embodiments 1 to 68. See, for example, other microstructured patterns and how the microstructured patterns are utilized to form nozzles in FIGS. 1A-1M and the description thereof in International Patent Application Serial No. US2012/023624.

In any of the above embodiments, nozzle 10 may comprise a nozzle plate 10 having a substantially flat configuration typically with at least a portion of inlet face 11 substantially parallel to at least a portion of outlet face 14.

It can be desirable for the thickness of a fuel injector nozzle 10 to be at least about 100 μm, preferably greater than about 200 μm; and less than about 3 mm, preferably less than about 1 mm, more preferably less than about 500 μm (or any thickness or thickness range between about 100 μm and 3 mm in increments of 1 μm). As shown in various figures, it can be desirable for the nozzles to have a thickness that is thinner in an inner region of the nozzle plate and thicker around the perimeter of the nozzle plate. For faster fuel spray breakup it can be desirable to decrease the thickness of the nozzle plate. Such a decrease, however, would likely produce a higher turbulence level at the nozzle outlet, which may result in the fuel spray breaking up quicker. As the thickness of the nozzle plate decreases, however, it becomes more difficult to maintain the rigidity or flatness of the nozzle plate during subsequent fabrication (e.g., machining) processes. The pressure upstream of the nozzle inlet in the fuel injector (especially with the higher pressures of a GDI systems) can also cause premature failure or unintended deflection of a nozzle plate that is too thin. In addition, as the nozzle plate thickness is decreased, it becomes increasingly difficult to produce a high quality weld (e.g., laser weld) of the nozzle plate onto the injector body. By making the inner region thinner and the perimeter thicker, the inventive nozzle be operatively adapted (e g , dimensioned, configured or otherwise designed) so as to strike a balance of the above needs.

Further, although not shown in the figures, any of the herein-described nozzles 10 may further comprise one or more alignment surface features that enable (1) alignment of nozzle 10 (i.e., in the x-y plane) relative to a fuel injector 101 and (2) rotational alignment/orientation of nozzle 10 (i.e., a proper rotational position within the x-y plane) relative to a fuel injector 101. The one or more alignment surface features aid in positioning nozzle 10 and nozzle through-holes 15 therein so as to be accurately and precisely directed at one or more target location lₜ as discussed above. The one or more alignment surface features on nozzle 10 may be present along inlet face 11, outlet face 14, periphery 19, or any combination of inlet face 11, outlet face 14 and periphery 19. Further, the one or more alignment surface features on nozzle 10 may comprise, but are not limited to, a visual marking, an indentation within nozzle 10, a raised surface portion along nozzle 10, or any combination of such alignment surface features.

It should be understood that although the above-described nozzles, nozzle plates, fuel injectors, fuel injector systems, and methods are described as “comprising” one or more components, features or steps, the above-described nozzles, nozzle plates, fuel injectors, fuel injector systems, and methods may “comprise,” “consists of,” or “consist essentially of” any of the above-described components and/or features and/or steps of the nozzles, nozzle plates, fuel injectors, fuel injector systems, and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a nozzle, nozzle plate, fuel injector, fuel injector system, and/or method that “comprises” a list of elements (e.g., components or features or steps) is not necessarily limited to only those elements (or components or features or steps), but may include other elements (or components or features or steps) not expressly listed or inherent to the nozzle, nozzle plate, fuel injector, fuel injector system, and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a nozzle, nozzle plate, fuel injector, fuel injector system, and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described nozzles, nozzle plates, fuel injectors, fuel injector systems, and/or methods may comprise, consist essentially of, or consist of any of the herein-described components and features, as shown in the figures with or without any additional feature(s) not shown in the figures. In other words, in some embodiments, the nozzles, nozzle plates, fuel injectors, fuel injector systems, and/or methods of the present invention may have any additional feature that is not specifically shown in the figures. In some embodiments, the nozzles, nozzle plates, fuel injectors, fuel injector systems, and/or methods of the present invention do not have any additional features other than those (i.e., some or all) shown in the figures, and such additional features, not shown in the figures, are specifically excluded from the nozzles, nozzle plates, fuel injectors, fuel injector systems, and/or methods.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

Nozzles, similar to exemplary nozzles 10 as shown in FIGS. 1, 3A-7 and 9-10, were prepared for use in fuel injector systems, similar to fuel injector system 100.

From the above disclosure of the general principles of the present invention and the preceding detailed description, those skilled in this art will readily comprehend the various modifications, re-arrangements and substitutions to which the present invention is susceptible, as well as the various advantages and benefits the present invention may provide. Therefore, the scope of the invention should be limited only by the following claims and equivalents thereof. In addition, it is understood to be within the scope of the present invention that the disclosed and claimed nozzles may be useful in other applications (i.e., not as fuel injector nozzles). Therefore, the scope of the invention may be broadened to include the use of the claimed and disclosed structures for such other applications.

1. A fuel injector nozzle comprising:
a non-coined three-dimensional inlet face comprising a first inlet surface and a second inlet surface, with said inlet face not being formed by a deformation process;
an outlet face opposite said inlet face; and
one or more first nozzle through-holes and one or more second nozzle through-holes, with each said first nozzle through-hole comprising at least one inlet opening on said first inlet surface connected to at least one outlet opening on said outlet face by a cavity defined by an interior surface, and each said second nozzle through-hole comprising at least one inlet opening on said second inlet surface connected to at least one outlet opening on said outlet face by a cavity defined by an interior surface,
wherein said first inlet surface is not coplanar with said second inlet surface.

2. The nozzle of claim 1, wherein said inlet face further comprises a first valve sealing surface between said first inlet surface and said second inlet surface, with said first valve sealing surface being operatively adapted to seal with a fuel injector valve so as to allow a fuel to pass through said second nozzle through-holes but not said first nozzle through-holes.

3. The nozzle of claim 1, wherein said inlet face further comprises a second valve sealing surface being operatively adapted to seal with a fuel injector valve so as to prevent a fuel from passing through said second nozzle through-holes.

4. The nozzle of claim 1, wherein said first inlet surface and said second inlet surface are parallel to each other.

5. The nozzle of claim 2, wherein said first valve sealing surface is operatively adapted to seal with an exterior sealing surface of a fuel injector valve so as to prevent a fuel from passing through said one or more first nozzle through-holes .

6. The nozzle of claim 2, wherein said first valve sealing surface is perpendicular to at least one of said first inlet surface and said second inlet surface.

7. The nozzle of claim 1, wherein said outlet face comprises a first outlet surface and a second outlet surface, with each outlet opening of said one or more first nozzle through-holes being on said first outlet surface, each outlet opening of said one or more second nozzle through-holes being on said second outlet surface, and said first outlet surface is not coplanar with said second outlet surface.

8. The nozzle of claim 7, wherein said first outlet surface and said second outlet surface are parallel to each other.

9. The nozzle of claim 1, wherein said outlet face comprises a first outlet surface and a second outlet surface, with said first outlet surface being disposed at an acute angle to said second outlet surface, and each outlet opening being on said first outlet surface.

10. The nozzle of claim 1, wherein said inlet face comprises (i) an outer perimeter portion of said inlet face, (ii) an outer perpendicular wall portion of said inlet face extending upward from said outer perimeter portion, (iii) an intermediate wall portion extending from said outer perpendicular wall portion, at least a portion of said intermediate wall portion representing said second inlet surface, (iv) an inner perpendicular wall portion extending upward from said intermediate wall portion, and (v) an uppermost portion, at least a portion of said uppermost portion representing said first inlet surface.

11. The nozzle of claim 1, wherein each of (i) said one or more first nozzle through-holes and (ii) said one or more second nozzle through-holes independently comprises two or more nozzle through-holes.

12. A fuel injector comprising the nozzle of claim 1.

13. A fuel injection system of a vehicle comprising the fuel injector of claim 12 and a fuel injector valve having a fuel injector valve contact surface;
wherein said fuel injection system provides at least three levels of fluid flow through said nozzle depending on a position of said fuel injector valve relative to said nozzle.

14. The fuel injection system of claim 13, wherein the at least three levels of fluid flow through said nozzle comprise (1) no fluid flow; (2) partial fluid flow, wherein fluid flows through said one or more second nozzle through-holes; and (3) full fluid flow, wherein fluid flows through said one or more first nozzle through-holes and said one or more second nozzle through-holes.

15. A method of making the nozzle of claim 1.

16. The nozzle of claim 2, wherein said inlet face further comprises a second valve sealing surface being operatively adapted to seal with a fuel injector valve so as to prevent a fuel from passing through said second nozzle through-holes.

17. The nozzle of claim 16, wherein said first inlet surface and said second inlet surface are parallel to each other.

18. The nozzle of claim 17, wherein said first valve sealing surface is operatively adapted to seal with an exterior sealing surface of a fuel injector valve so as to prevent a fuel from passing through said one or more first nozzle through-holes .

19. The nozzle of claim 18, wherein said first valve sealing surface is perpendicular to at least one of said first inlet surface and said second inlet surface.

20. The nozzle of claim 19, wherein said outlet face comprises a first outlet surface and a second outlet surface, with each outlet opening of said one or more first nozzle through-holes being on said first outlet surface, each outlet opening of said one or more second nozzle through-holes being on said second outlet surface, and said first outlet surface is not coplanar with said second outlet surface.
